(19) United States
(12) Patent Application Publication
(10) Pub. No.: US 2026/0177114 A1
(43) Pub. Date: Jun. 25, 2026

(54) STRIP SPRING AND BRAKE PAD ASSEMBLY, BRAKE CALIPER, BRAKE PAD

(71) Applicant: Brembo N.V., Bergamo (IT)

(72) Inventors: Cristian CRIPPA, Bergamo (IT); Alberto PENDESINI, Bergamo (IT)

(21) Appl. No.: 19/430,765

(22) Filed: Dec. 23, 2025

(30) Foreign Application Priority Data
Dec. 23, 2024 (IT) 102024000029694

(51) Int. Cl. F16D 65/097; F16D 65/00; F16D 65/18; F16D 127/02

(52) U.S. Cl. CPC F16D 65/0972; F16D 65/0075; F16D 65/183; F16D 2127/02

(57) ABSTRACT

The object of the present invention is a leaf spring and brake pad assembly (1) for a brake caliper (6). The assembly includes a brake pad (5) with a backing plate (10) and friction material (11) that presses against a brake disc (3). The backing plate (10) has a radially outer edge (16) with at least two thrust portions (12, 112). The assembly includes at least two leaf springs (2, 102). Each spring has a fastening portion (8) for attachment to the caliper body (7) and a spring thrust portion (9) that contacts the brake pad (5) at the thrust portion (12). This contact exerts an elastic force on the pad to move it away from the brake disc (3). Each thrust portion (12, 112) includes at least one ramp (18) inclined relative to the axial direction (A-A) and radial direction (R-R). The ramp extends radially and axially from the friction material (11). The radially outer edge (20) of each thrust portion has at least one convex portion (21) with a concavity facing radially inward (R-I). The leaf springs (2, 102) are symmetrically arranged with respect to the center plane (A-R) and act on the central part (22) of the convex portion (21), exerting parallel and equidistant forces from the center plane (A-R). This pushes the brake pad (5) away from the disc (3) in the axial direction (A-A), avoiding contact with the lateral parts (23, 24) of the convex portion.

### FIELD OF THE INVENTION

The present invention relates to a strip spring and brake pad assembly, as well as to a brake caliper, and to a brake pad.

### PRIOR ART

In a disc brake, the brake caliper is generally arranged straddling the outer peripheral edge of a brake disc, suitable for rotating about a rotation axis (X-X) defining an axial direction (A-A). In a disc brake, a radial direction (R-R), substantially orthogonal to said axial direction (A-A), and a circumferential direction (C-C), orthogonal both to said axial direction (A-A) and to said radial direction (R-R), as well as a tangential direction (T-T), locally or rather punctually, that is in a point of intersection between an axial and radial direction, orthogonal both to said axial direction (A-A) and said radial direction (R-R), are also defined.

As known, brake discs for disc brakes comprise a bell, suitable for associating the disc with a hub of a vehicle, from which extends an annular portion, called braking surface, intended to cooperate with brake pads of a caliper.

Springs for disc brakes are known, constituted by a central portion and two end portions, wherein the end portions are rested against the pads so as to elastically bias the pads away from each other to ensure separation of the pads from the brake disc after each braking. According to a known type of such springs, the central portion of the springs is fixed to the caliper, maintaining the spring in its operational position. These known springs are used to achieve a reduction in vibrations of the pads; a distancing of the pads from the brake disc to reduce or eliminate a residual braking torque (residual torque) due to undesired contacts between the pads and the brake disc when the brake is released; as well as to achieve uniform wear of the friction linings of the pads.

In particular, the springs of the known art generally comprise one or more coupling appendages, formed at the central portion of the spring, suitable for connecting the springs to the caliper at coupling portions formed on the caliper.

For example, springs are known which are connected to the caliper body so as to be arranged straddling the brake disc in two tangentially opposite portions so as to act on the brake pad at its two opposite lateral portions. This type of springs is known from documents WO2019/243958 and WO2020/128710, in which at least two springs are used which are connected and elastically interposed respectively with a first lateral bridge of the caliper body and at least one central bridge of the caliper body, and with a second lateral bridge of the caliper body and the at least one central bridge of the caliper body. These springs contact a radially outer edge of the plate of the pad at respective lateral ears of the brake pad. Although satisfactory, these solutions are bulky, requiring the use of two springs acting on diametrically opposite retainers of the pad.

Therefore, a felt need in the field is to develop spring and pad solutions that allow for a reduction in their weight and bulk compared to the known art, thereby enabling the manufacture of more compact and lighter caliper bodies, while maintaining substantially unchanged, if not improved, the interaction properties between spring and pad.

Other spring and spring-pad assembly solutions are known, for example from document WO201118815. In this case, it is provided to use at least one spring which contacts a central portion of the pad, at its upper edge, or radially outer edge. Although satisfactory in many respects, it has been found that the bending configuration of this spring in combination with the contact portion of the pad generates high friction which reduces the efficiency of detachment of the pad from the brake disc, and consequently reduces and/or eliminates the residual torque.

Therefore, a felt need in the field is to develop brake springs and pads that allow for reduced bulk, enabling the manufacture of more compact caliper bodies, without affecting the resulting deformation of the caliper body, allowing for safe and reliable positioning of the spring on the pad, and at the same time reduced friction sliding between spring and pad compared to the known art.

Patent WO202403804, by the same applicant as the present patent application, describes a strip spring and brake pad assembly for disc brake calipers, with the aim of improving efficiency, compactness, and ease of assembly compared to pre-existing solutions. The disclosure focuses on a particular geometry of the thrust portion of the brake pad and on a self-centering design of the strip spring, focused on the conformation of the thrust portion of the brake pad positioned astride the axial-radial centerline plane of the pad. This portion is delimited by an inclined ramp and presents, along its radially outer edge, at least one convex portion. The strip spring is shaped to exert its elastic action on the central part of this convex portion, avoiding contact with the side parts. This configuration significantly reduces the contact areas between spring and pad, minimizing friction and allowing rapid and efficient detachment of the pad from the brake disc after braking. A further aspect of the disclosure concerns the design of the strip spring, which is self-centering relative to the brake pad. The width of the thrust portion of the spring is calculated so as to interfere with the central part of the convex portion present on the pad. This allows for stable positioning of the spring, simplifying assembly and ensuring optimal contact between the two components. The most important aspect of the disclosure lies in positioning the thrust portion, imparted by the spring to the brake pad, near the centre of gravity of the friction material. This solution allows the spring's elastic force to be applied in a balanced manner, minimising pad deformation and further improving its retraction from the disc.

This known solution is not without drawbacks. In particular, the thrust zone of the strip spring, positioned exactly on the centerline plane of the brake pad, creates considerable drawbacks regarding the long-term effectiveness of the proposed solution. The central thrust position, theoretically ideal for symmetrical retraction of the pad, becomes a critical point in real-world situations, where wear of the components and accumulation of debris are inevitable. Even a minimal variation in the uniform thickness of the spring, irregular wear of the support surface on the plate, or the presence of dust or dirt (a common issue in braking systems), is enough to generate a thrust force no longer perfectly balanced. This asymmetry in the applied force induces skewing of the pad, that is, movement of the pad no longer parallel to the braking surface of the disc, with a resulting non-uniform retraction of the pad from the brake disc. In this scenario, part of the pad could remain in contact with the disc even when the brake is not actuated, generating a harmful residual torque. The consequences of this residual torque are multiple and negative: increased fuel consumption, disturbing noise, squealing, and uneven wear of the pad itself. The objective of the proposed solution in this patent, namely an efficient and silent braking system, would thus be nullified.

Therefore, a felt need in the field is to develop brake springs and pads that enable uniform retraction of the pad along its entire extension, even in the presence of:
wear of the strip spring;
wear of the support plate of the pad in the area of contact with the spring;
accumulation of dirt or debris on the contact surfaces between spring and pad.

A thrust system that meets this need must be able to compensate for any variations in the geometry of the contact point, ensuring a more uniform and stable force distribution over time. In this way, skewing of the pad, the generation of residual torque, and its negative consequences (uneven wear, noise, fuel consumption) would be avoided.

### Solution

The present invention aims to provide a strip spring and brake pad assembly, in which low-friction sliding between the spring and the pad is permitted.

This and other objects and advantages are achieved with a strip spring and brake pad assembly according to claim 1, with a brake caliper according to claim 11, with a brake pad according to claim 15.

Some advantageous embodiments are the subject of the dependent claims.

Thanks to the proposed solutions, it is possible to avoid skewing of the pad even under the most severe operating conditions, both in terms of component wear and of harsh and dirty working environment of the braking system.

Furthermore, thanks to the proposed geometries of the pad and strip spring, it is possible to facilitate the assembly of the strip spring onto the pad through a self-centering coupling.

Furthermore, thanks to the proposed geometries of the pad and strip spring, it is possible to limit the contact and sliding zones between the pad and the strip spring to a minimum of one contact and sliding zone up to a maximum of two contact and sliding zones, allowing extremely responsive retraction of the brake pad from the brake disc.

### FIGURES

Further features and advantages of the strip spring and brake pad assembly, of the brake caliper and of the brake pad will appear from the description set out below of preferred embodiments, given by way of non-limiting example, with reference to the accompanying drawings in which:

FIG. 1 shows in axonometric view a brake caliper according to a first embodiment, in which two strip spring and brake pad assemblies according to the present invention are provided, in particular with a pair of strip springs each interacting with two opposite brake pads, wherein the strip springs are connected to the caliper body exclusively at a tangential tie-rod;

FIG. 2 shows a top view of the brake caliper of FIG. 1;

FIG. 3 shows in axonometric view a strip spring of the assembly according to the present invention, suitable for being used in the brake caliper of FIG. 1;

FIG. 4 shows a side view of the strip spring of FIG. 3, in which the spring thrust portion is visible, shaped with two arms;

FIG. 5 shows a front view of a brake pad of the assembly according to the present invention, according to a first embodiment, wherein the brake pad comprises two thrust portions suitable to slide and come into contact with the strip spring according to the embodiments of the present invention, wherein each thrust portion is curved and presents a radially outer maximum so that the spring contacts the pad only at said radially outer maximum to retract the brake pad in the absence of braking and wherein the two thrust portions are mutually specular with respect to a centerline and symmetry plane of the pad indicated as A-R;

FIG. 6 shows a front view of the brake caliper of FIG. 1 sectioned along a plane containing the radial and circumferential directions, wherein the brake pad of FIG. 5 is visible coupled with two strip springs of FIG. 3, with coupling arms coupled in pairs to the tangential tie-rod of the caliper body;

FIG. 7 shows a front view from the back side of the brake pad and in section, the strip spring and brake pad assembly of FIG. 6, in which thrust elements or pistons of the brake caliper are shown;

FIGS. 8, 9 and 10 show in cross-section the strip spring and brake pad assembly, sectioned along section planes containing the radial and axial directions, each slightly offset in the circumferential direction, so as to show that each strip spring and the pad are in contact only at a central part of the thrust end of the spring and a central part of the thrust portion of the plate;

FIG. 11 shows in axonometric view two brake pads of the strip spring and brake pad assembly according to the present invention together with the brake pad support and sliding pins, wherein the brake pad is sectioned along a plane containing the radial and axial directions, and wherein each thrust portion is suitable to slide and come into contact with the strip spring according to the embodiments of the present invention;

FIG. 12 shows in axonometric view a first enlargement of FIG. 11;

FIG. 13 shows in axonometric view a second enlargement of FIG. 11;

FIG. 14 shows in axonometric sectional view according to a plane containing the circumferential and radial directions a detail of the brake caliper and of the tangential tie-rod to which a strip spring influencing a pad is connected;

FIG. 15 shows in axonometric sectional view according to a plane containing the axial and radial directions a detail of the brake caliper and of the tangential tie-rod to which the strip spring influencing the pads is connected;

FIG. 16 shows in axonometric sectional view according to a plane containing the axial and radial directions a detail of the brake caliper and of the tangential tie-rod to which the strip spring influencing the pads is connected, in which the seat in the body of the tangential tie-rod is highlighted, allowing the safe snap-fit coupling of the coupling portion of the strip spring;

FIG. 17 shows in front view a detail of a pad according to a further embodiment of the spring seat;

FIG. 18 shows in top view a brake caliper according to a further embodiment in which a third strip spring is provided at the centerline plane A-R and is constrained to a tangential tie-rod;

FIG. 19 shows in top view a brake caliper according to a further embodiment in which a third strip spring is provided at the centerline plane A-R and is constrained to a pair of axial tie-rods.

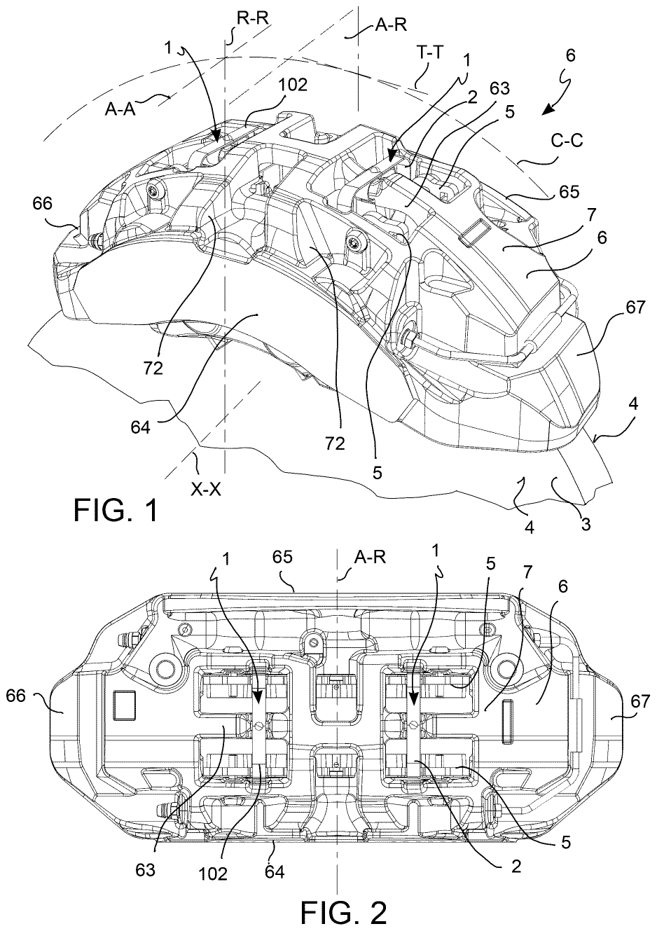

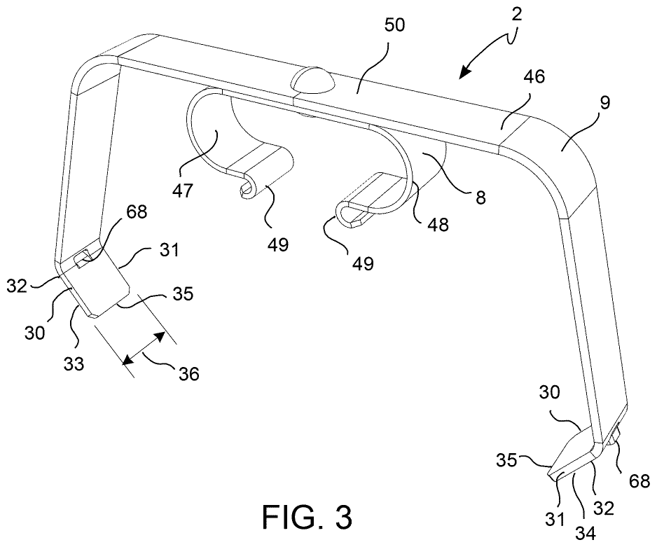

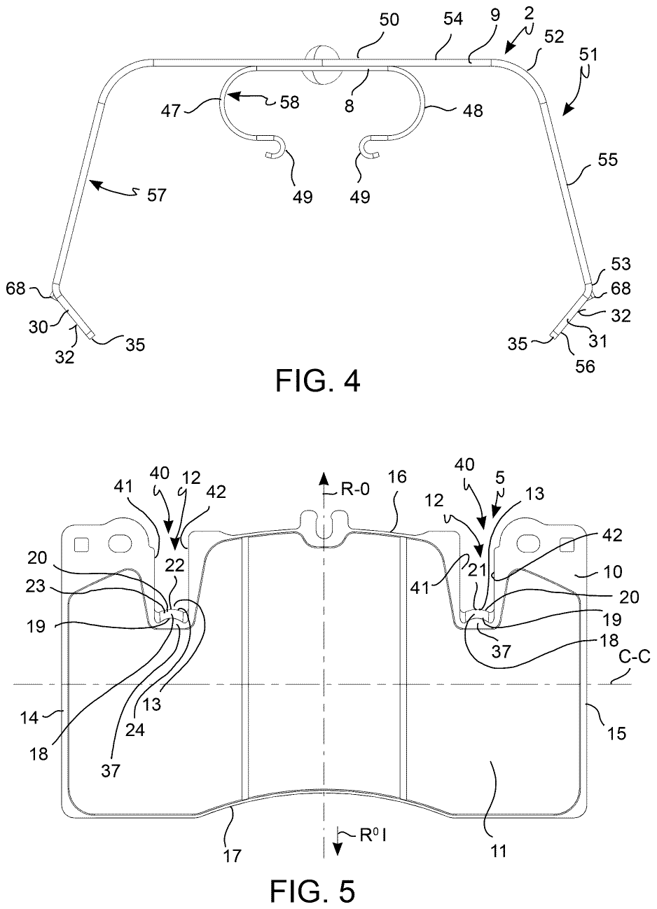

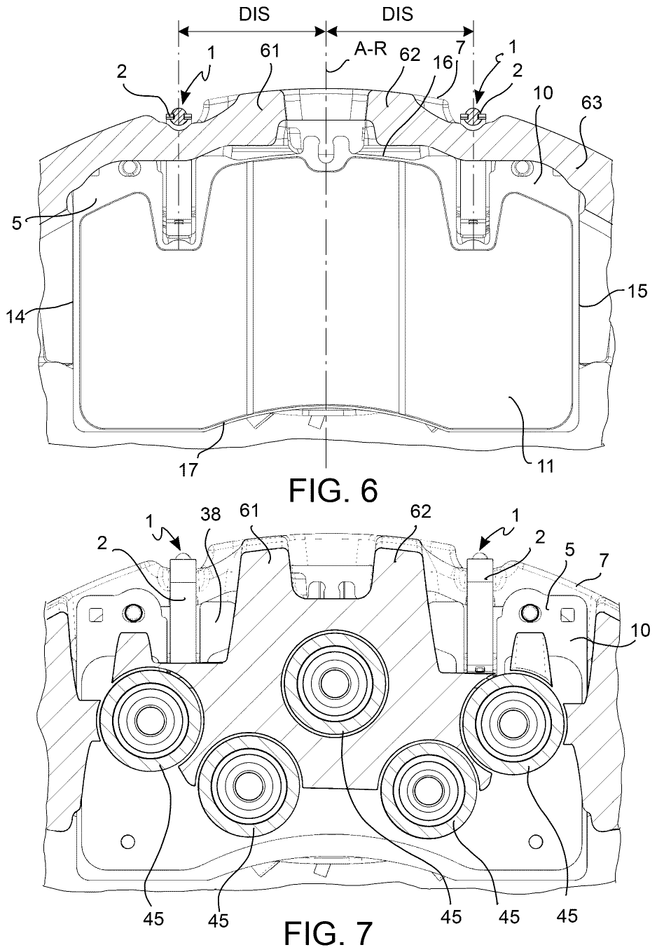

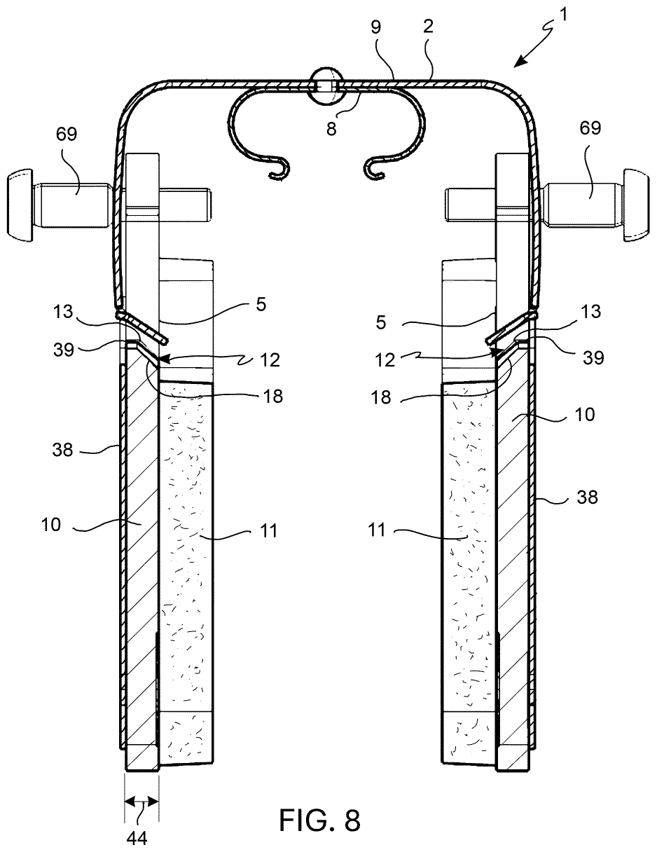

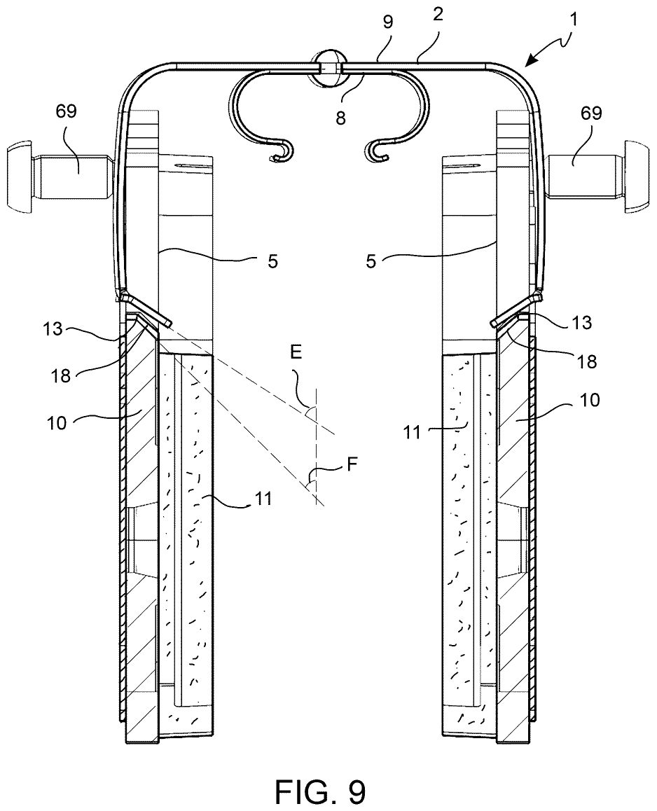

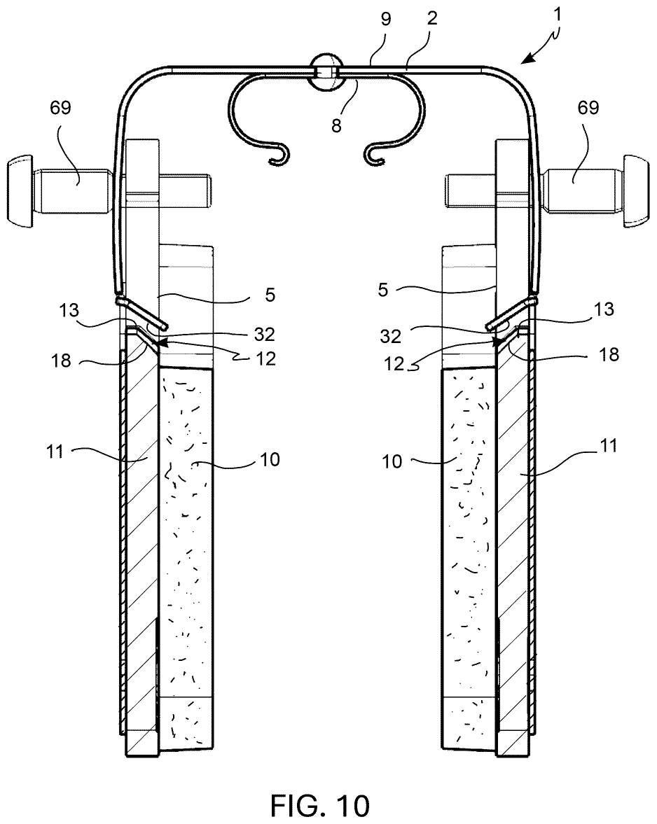

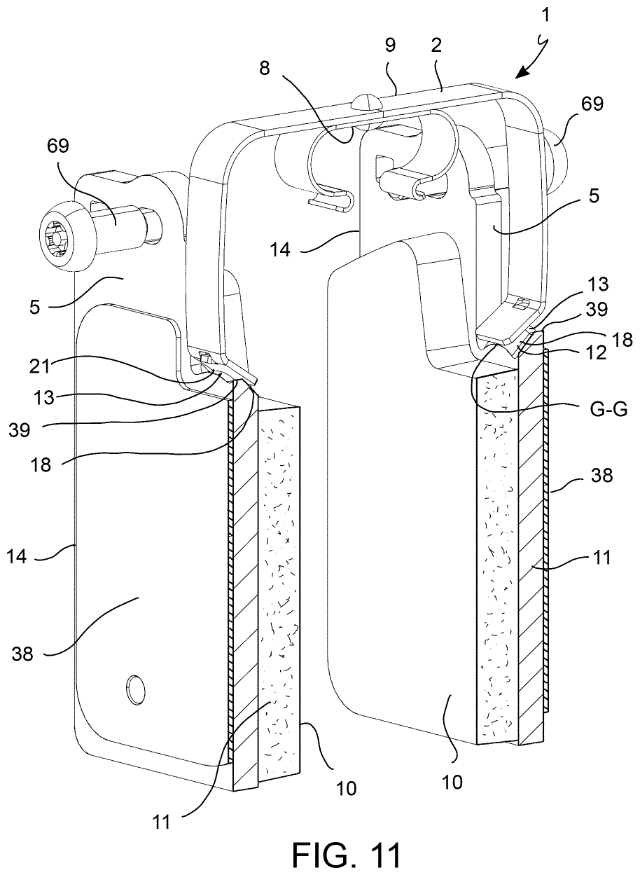

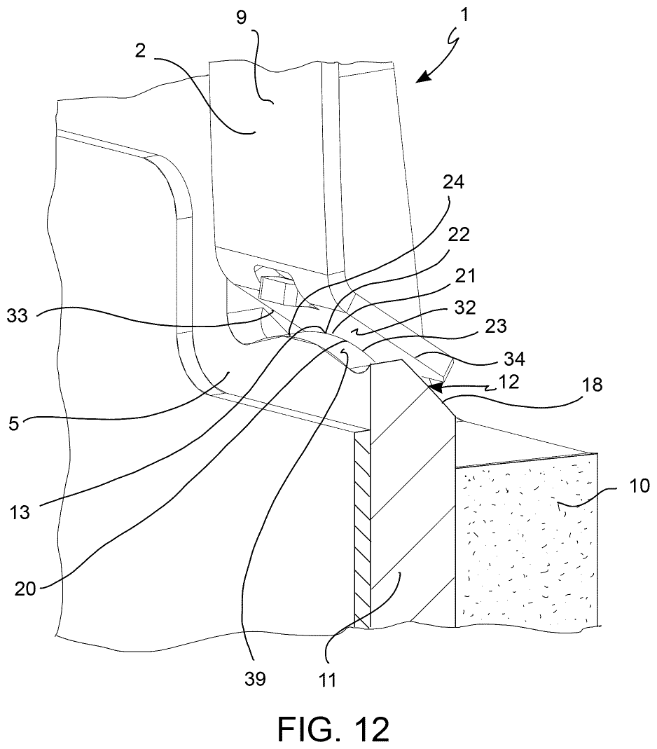

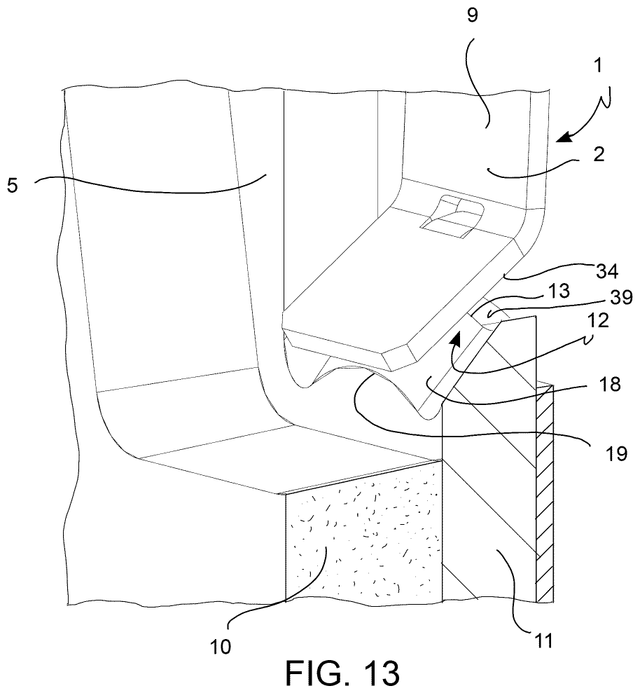

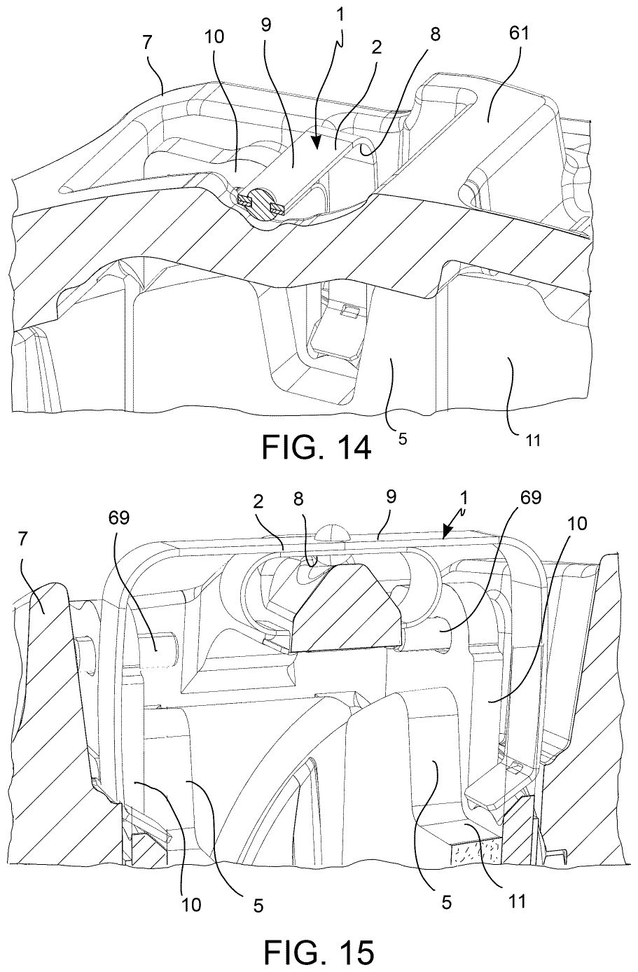

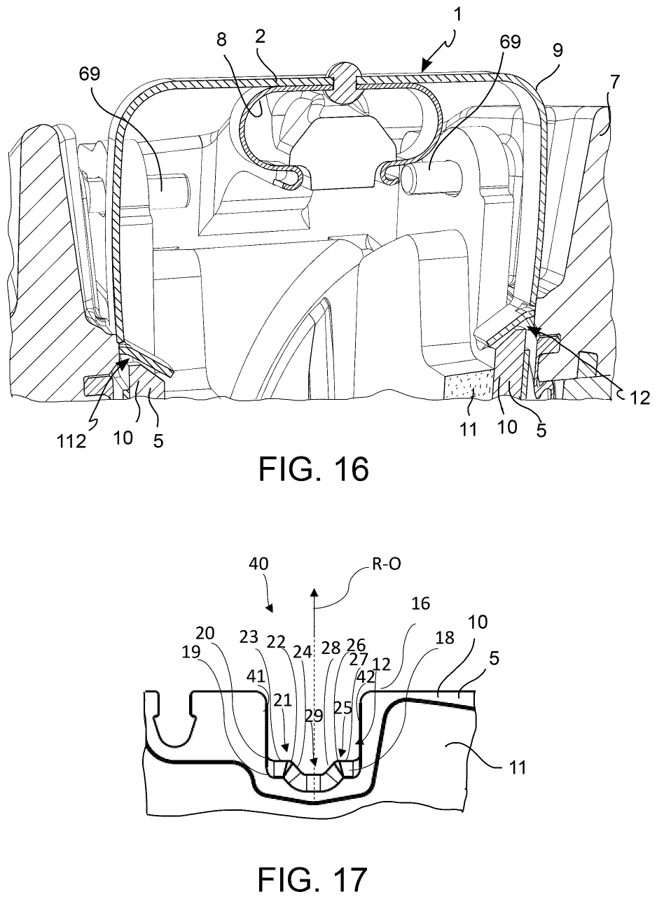

### DESCRIPTION OF SOME PREFERRED EMBODIMENTS

According to a first general embodiment, the invention relates to a strip spring and brake pad assembly 1 for a brake caliper 6.

Said assembly 1 defines an axial direction A-A, a radial direction R-R perpendicular to the axial direction A-A, and a circumferential direction C-C, perpendicular both to said axial direction A-A and to said radial direction R-R.

Said assembly 1 comprises a brake pad 5 comprising a plate 10 and a friction material 11 supported by the plate 10, wherein the friction material 11 is adapted to press against a braking surface 4 of a brake disc 3, wherein said brake disc 3 has a rotation axis X-X about which it rotates, wherein the rotation axis X-X is parallel to the axial direction A-A.

The plate 10 comprises a first tangentially outer edge 14 and a second tangentially outer edge 15 which are diametrically opposite or specular with respect to a centerline plane A-R, wherein said centerline plane A-R is parallel to said axial direction A-A and to said radial direction R-R.

The plate 10 comprises a radially outer edge 16 and a radially inner edge 17, wherein said radially outer edge 16 faces at least partially along said radial direction R-R radially outwards R-O away from the rotation axis X-X, wherein said radially inner edge 17 faces at least partially along said radial direction R-R radially inwards R-I towards the rotation axis X-X.

Said radially outer edge 16 comprises at least two thrust portions 12, 112.

Said assembly 1 comprises at least two strip springs 2, 102, each comprising a coupling portion 8 configured to connect to a caliper body 7, at least one spring thrust portion 9 configured to contact said brake pad 5 at said thrust portion 12 to apply an elastic bias to said brake pad 5 to move it away from the brake disc 3, wherein the spring thrust portion 9 is connected to said coupling portion 8.

Two of said at least two strip springs 2, 102 are arranged on opposite sides of said centerline plane A-R at predefined distances DIS mutually equal and specular with respect to said centerline plane A-R, and wherein two of said at least two thrust portions 12, 112 are arranged on opposite sides of said centerline plane A-R, at predefined distances DIS mutually equal and specular with respect to said centerline plane A-R.

Each strip spring 2, 102 is adapted to apply with said spring thrust portion 9 said elastic bias to the respective thrust portion 12, 112 arranged on the same side of said centerline plane A-R where each strip spring 12, 112 is located, so that two spring thrust portions 9 of said at least two strip springs 2, 102 influence said brake pad 5 at least in moving it away from said brake disc 3 in the axial direction A-A.

Said coupling portion 8 comprises at least a first coupling arm 47 and a second coupling arm 48 configured to couple the strip spring 2 to the caliper body 6.

Each coupling arm 47, 48 extends from a central spring portion 50 to a respective coupling end 49.

Said first coupling arm 47 and said second coupling arm 48 are substantially U-bent.

The first coupling arm 47 and the second coupling arm 48 are configured to embrace a tangential tie-rod 63 which is parallel to the brake disc 3.

According to a first general embodiment, the invention relates to a strip spring and brake pad assembly 1 for a brake caliper 6.

Said assembly 1 defines an axial direction A-A, a radial direction R-R perpendicular to the axial direction A-A, and a circumferential direction C-C, perpendicular both to said axial direction A-A and to said radial direction R-R.

Said brake caliper 6 comprises a caliper body 7 adapted to straddle a brake disc 3, wherein said caliper body 7 comprises a first elongated element 64, a second elongated element 65, a first end connection bridge 66, and a second end connection bridge 67 which connect said first elongated element 64 and said second elongated element 65 from tangentially opposite sides.

Said assembly 1 comprises a brake pad 5 comprising a plate 10 and a friction material 11 supported by the plate 10, wherein the friction material 11 is adapted to press against a braking surface 4 of a brake disc 3, wherein said brake disc 3 has a rotation axis X-X about which it rotates, wherein the rotation axis X-X is parallel to the axial direction A-A.

The plate 10 comprises a first tangentially outer edge 14 and a second tangentially outer edge 15 which are diametrically opposite or specular with respect to a centerline plane A-R, wherein said centerline plane A-R is parallel to said axial direction A-A and to said radial direction R-R.

The plate 10 comprises a radially outer edge 16 and a radially inner edge 17, wherein said radially outer edge 16 faces at least partially along said radial direction R-R radially outwards R-O away from the rotation axis X-X, and wherein said radially inner edge 17 faces at least partially along said radial direction R-R radially inwards R-I towards the rotation axis X-X.

Said radially outer edge 16 comprises at least two thrust portions 12, 112.

Said assembly 1 comprises at least two strip springs 2, 102, each comprising a coupling portion 8 configured to connect to a caliper body 7, at least one spring thrust portion 9 configured to contact said brake pad 5 at said thrust portion 12 to apply an elastic bias to said brake pad 5 to move it away from the brake disc 3, wherein the spring thrust portion 9 is connected to said coupling portion 8.

Said brake caliper 6 comprises a tangential tie-rod 63 which connects said first connection bridge 66 to said second connection bridge 67 along said circumferential direction C-C, above said brake disc 3, wherein said at least two strip springs 2, 102 are hooked to said tangential tie-rod 63 on opposite sides with respect to said centerline plane A-R and mutually equally spaced apart from said centerline plane A-R.

Two of said at least two thrust portions 12, 112 are arranged on opposite sides of said centerline plane A-R, at predefined distances DIS mutually equal and specular with respect to said centerline plane A-R.

Each strip spring 2, 102 is adapted to apply with said spring thrust portion 9 said elastic bias to the respective thrust portion 12, 112 arranged on the same side of said centerline plane A-R where each strip spring 12, 112 is located, so that two spring thrust portions 9 of said at least two strip springs 2, 102 influence said brake pad 5 at least in moving it away from said brake disc 3 in the axial direction A-A.

Said coupling portion 8 comprises at least a first coupling arm 47 and a second coupling arm 48 configured to couple the strip spring 2 to the caliper body 6.

According to a general embodiment, the invention relates to a strip spring and brake pad assembly 1 for a brake caliper 6. Said assembly 1 defines an axial direction A-A, a radial direction R-R perpendicular to the axial direction A-A, and a circumferential direction C-C, perpendicular both to said axial direction A-A and to said radial direction R-R. Said assembly 1 comprises a brake pad 5 comprising a plate 10 and a friction material 11 supported by the plate 10. The friction material 11 is adapted to press against a braking surface 4 of a brake disc 3. Said brake disc 3 has a rotation axis X-X about which it rotates. The rotation axis X-X is parallel to the axial direction A-A. The plate 10 comprises a first tangentially outer edge 14 and a second tangentially outer edge 15 which are diametrically opposite or specular with respect to a centerline plane A-R. Said centerline plane A-R is parallel to said axial direction A-A and to said radial direction R-R. According to one embodiment, said first tangentially outer edge 14 and said second tangentially outer edge 15 extend predominantly in a rectilinear manner in the radial direction R-R. The plate 10 comprises a radially outer edge 16 and a radially inner edge 17. Said radially outer edge 16 faces at least partially along said radial direction R-R radially outwards R-O away from the rotation axis X-X. Said radially inner edge 17 faces at least partially along said radial direction R-R radially inwards R-I towards the rotation axis X-X. Said radially outer edge 16 comprises at least two thrust portions 12, 112. Said assembly 1 comprises at least two strip springs 2, 102, each comprising a coupling portion 8 configured to connect to a caliper body 7, at least one spring thrust portion 9 configured to contact said brake pad 5 at said thrust portion 12 to apply an elastic bias to said brake pad 5 to move it away from the brake disc 3. The spring thrust portion 9 is connected to said coupling portion 8. Each of said at least two thrust portions 12, 112 is delimited at least by a ramp 18. The ramp 18 is inclined at least with respect to the axial direction A-A and said radial direction R-R. Said ramp 18 faces the same side as the friction material 11. Said ramp 18 extends radially and axially away from said friction material 11 between a radially inner edge 19 and a radially outer edge 20. Said radially outer edge 20 extends at least in the radial direction R-R and at least in the tangential direction C-C. Two of said at least two strip springs 2, 102 are arranged on opposite sides of said centerline plane A-R at predefined distances DIS mutually equal and specular with respect to said centerline plane A-R, and two of said at least two thrust portions 12, 112 are arranged on opposite sides of said centerline plane A-R, at predefined distances DIS mutually equal and specular with respect to said centerline plane A-R. Said radially outer edge 20 of each of said at least two thrust portions 12, 112 comprises at least a first convex portion 21. Said first convex portion 21 forms a first concavity facing radially inwards R-I. Said first convex portion 21 comprises a first central part 22, a first side part 23, and a second side part 24. The first central part 22 is interposed between the first side part 23 and the second side part 24. Each strip spring 2, 102 is adapted to apply with said spring thrust portion 9 said elastic bias at least partially to the first central part 22 of said first convex portion 21, so that two spring thrust portions 9 of said at least two strip springs 2, 102 influence said brake pad 5 at least in moving it away from said brake disc 3 in the axial direction A-A, avoiding contact with the first side part 23 and the second side part 24 of said first convex portion 21 and applying forces parallel to each other and substantially equally spaced apart from said centerline plane A-R.

According to one embodiment, the radially outer edge 20 comprises at least a second convex portion 25 which forms a second concavity facing radially inwards R-I.

According to one embodiment, said radially outer edge 20 comprises at least one concave portion 29 which forms a third concavity facing radially outwards R-O. According to one embodiment, said concave portion 29 is central with respect to said first convex portion 21 and said second convex portion 25.

According to one embodiment, said spring thrust portion 9 applies said elastic bias to said first convex portion 21 and to said second convex portion 25, influencing said brake pad 5 at least in moving it away from said brake disc 3 in the axial direction A-A, avoiding contact with said concave portion 29.

According to one embodiment, said second convex portion 25 comprises a second central part 26, a third lateral part 27, and a fourth lateral part 28. According to one embodiment, the second central part 26 is interposed between the third lateral part 27 and the fourth lateral part 28. According to one embodiment, the strip spring 2 is adapted to exert with said spring thrust portion 9 said elastic bias at least partially on the second central part 26 of said second convex portion 25, influencing said brake pad 5 at least in retraction from said brake disc 4 in the axial direction A-A, avoiding contact with the third lateral part 27 and the fourth lateral part 28 of said second convex portion 25.

According to one embodiment, said spring thrust portion 9 applies said elastic bias to said first convex portion 21 and to said second convex portion 25, influencing said brake pad 5 at least in retraction from said brake disc 3 in the axial direction A-A and in the radial direction R-R, contacting exclusively said first convex portion 21 and said second convex portion 25, and avoiding any other contact with said brake pad 5 by said spring thrust portion 9. According to one embodiment, said concave portion 29 is radially internal with respect to said first convex portion 21 and said second convex portion 25. According to one embodiment, said concave portion 29, in said at least two ramps 18, is equidistant from said centerline plane A-R.

According to one embodiment, said spring thrust portion 9 comprises a first spring edge 30 and a second spring edge 31, which are tangentially opposite to each other. According to one embodiment, said spring thrust portion 9 contacts said first convex portion 21 with said first spring edge 30 and said second convex portion 25 with said second spring edge 31. According to one embodiment, said spring thrust portion 9 comprises a radially inner face 32 facing radially inward R-I toward said brake pad 5. According to one embodiment, said radially inner face 32 extends along said circumferential direction C-C between a first spring edge 33 and a second spring edge 34. According to one embodiment, said spring thrust portion 9 contacts said first convex portion 21 with said first spring edge 33 and said second convex portion 25 with said second spring edge 34. According to one embodiment, said spring thrust portion 9 comprises a thrust end 35 configured to contact said brake pad 5. According to one embodiment, said thrust end 35 defines a spring thrust portion width 36. According to one embodiment, between said second lateral part 24 of said first convex portion 21 and said fourth lateral part 28 of said second convex portion 25 a first tangential distance runs along said circumferential direction C-C or a direction parallel thereto. According to one embodiment, between said first lateral part 23 of said first convex portion 21 and said third lateral part 27 of said second convex portion 25 there is a second tangential distance along said circumferential direction C-C or a direction parallel thereto. According to one embodiment, said spring thrust portion width 36 is greater than said first tangential distance and less than said second tangential distance, so that said thrust end 35 interferes with said first central part 22 and said second central part 27, self-centering with respect to said thrust portion 12.

According to one embodiment, the first central part 22 is radially external to said first lateral part 23 and said second lateral part 24. According to one embodiment, said first central part 22 is crossed by a plane parallel to said centerline plane A-R with respect to said axial direction A-A. According to one embodiment, said first central part 22 forms a radially outer apical portion of said radially outer edge 20. According to one embodiment, said first central part 22 is the most radially external portion of said radially outer edge 20. According to one embodiment, the strip spring 2 is adapted to apply with said spring thrust portion 9 said elastic bias exclusively on the first central part 22 of said first convex portion 21, influencing said brake pad 5 at least in retraction from said brake disc 3 in the axial and radial directions A-A and R-R.

According to one embodiment, said first convex portion 21 is a curved portion of said thrust portion 12 that forms a radially outer maximum of said thrust portion 12. According to one embodiment, said radially outer edge 20 comprises two concave portions 29 tangentially opposite with respect to said at least one first convex portion 21. According to one embodiment, said first convex portion 21 is radially external to said two concave portions 29. According to one embodiment, the strip spring 2 is adapted to apply with said spring thrust portion 9 said elastic bias on the first convex portion 21, avoiding contact with said two concave portions 29.

According to one embodiment, said plate 10 comprises a free front surface 37 around the friction material 11. According to one embodiment, the free front surface 37 faces the same side as the friction material 11. According to one embodiment, said plate 10 comprises a back 38 that delimits the plate 10 on the side axially opposite to the friction material 11. According to one embodiment, said back 38 is suitable to face at least one thrust element 45 of the brake caliper 6. According to one embodiment, said radially inner edge 19 is defined by the intersection of said ramp 18 and said free front surface 37. According to one embodiment, said thrust portion 12 is delimited by an axial edge 39 that extends along said axial direction A-A between said ramp 18 and said back 38. According to one embodiment, said radially outer edge 20 is defined by the intersection of said ramp 18 with said axial edge 39. According to one embodiment, said spring thrust portion 9 comprises a thrust end 35 suitable to contact said brake pad 5. According to one embodiment, said thrust end 35 is bent with respect to said radial direction R-R in a direction opposite to said brake pad 5 by a spring angle E. According to one embodiment, said ramp 18 is inclined with respect to said radial direction R-R by a ramp angle F. According to one embodiment, said ramp angle F is smaller than said spring angle E so as to avoid contact between said ramp 18 and said strip spring 2.

According to one embodiment, said plate 11 defines a spring seat 40 adapted to receive said spring thrust portion 9. According to one embodiment, said spring seat 40 passes at least through a thickness of the plate. According to one embodiment, said plate 11 comprises a first lateral seat wall 41 and a second lateral seat wall 42 which are connected to said thrust portion 12 and extend from said thrust portion 12 at least in the radial direction R-R, delimiting tangentially from opposite sides said spring seat 40. According to one embodiment, said spring seat 40 is delimited by said thrust portion 12 along said radial direction R-R toward the radially inner direction R-I. According to one embodiment, said spring seat 40 is open in the radially outer direction R-O or closed by a radially inner wall 43 facing radially inward R-I. According to one embodiment, in said spring seat 40 the brake pad 5 passes so as to position said thrust portion 12 near a barycenter of the friction material 10 or a thrust center of the brake pad 5.

According to one embodiment, said strip spring 2 comprises a spring body 46. According to one embodiment, said coupling portion 8 comprises at least a first coupling arm 47 and a second coupling arm 48 configured to secure the strip spring 2 to the caliper body 6. According to one embodiment, each coupling arm 47, 48 extends from a central spring portion 50 to a respective coupling end 49. According to one embodiment, said first coupling arm 47 and said second coupling arm 48 are substantially U-shaped. According to one embodiment, said strip spring 2 comprises at least a first thrust arm 51 extending from the central spring portion 50 to the spring thrust portion 9. According to one embodiment, the spring thrust portion 9 has a respective thrust end 35.

According to a general embodiment, the invention relates to a brake caliper 6 comprising a caliper body 7 suitable to straddle a brake disc 3. Said caliper body 7 comprises a first elongated element 64, a second elongated element 65, a first end connection bridge 66, and a second end connection bridge 67 connecting said first elongated element 64 and said second elongated element 65 from tangentially opposite sides. The brake caliper 6 comprises at least one strip spring and brake pad assembly 1 according to any of the preceding claims. Said brake pad 5 is supported and housed by said caliper body 7. The brake caliper 6 comprises at least one thrust element or piston 45 housed in said first elongated element 64 and/or in said second elongated element 65 to influence said at least one brake pad 5 toward the brake disc 3.

According to one embodiment, the brake caliper 6 comprises a tangential tie-rod 63 connecting said first connection bridge 66 to said second connection bridge 67 along said circumferential direction C-C, overlying said brake disc 3. According to one embodiment, the at least two strip springs 2, 102 are hooked to said tangential tie-rod 63 on opposite sides of said centerline plane A-R and are equidistant from said centerline plane A-R. According to one embodiment, said tangential tie-rod 63 has an axial bulk or axial thickness 71 that is smaller than a spring thrust portion width 36 of said thrust portion 9.

According to one embodiment, the radially outer edge 16 comprises at least three thrust portions 12, 112, 212 as defined in claim 1. According to one embodiment, the assembly 1 comprises at least three strip springs 2, 102, 202 as defined in claim 1.

According to one embodiment, two of said at least three strip springs 2, 102, 202 are arranged on opposite sides of said centerline plane A-R at predefined distances DIS that are equal and symmetrical with respect to said centerline plane A-R. According to one embodiment, two of said at least three thrust portions 12, 112, 212 are arranged on opposite sides of said centerline plane A-R at predefined distances DIS that are equal and symmetrical with respect to said centerline plane A-R. According to one embodiment, the third of said at least three strip springs 2, 102, 202 is arranged so as to cross said centerline plane A-R. According to one embodiment, the third of said at least three thrust portions 12, 112, 212 is arranged so as to cross said centerline plane A-R. According to one embodiment, the brake caliper 6 comprises at least a first axial tie-rod 61 connecting said first elongated element 64 to said second elongated element 65 in the axial direction A-A. According to one embodiment, the third of said strip springs 2 is hooked to said first axial tie-rod 61, avoiding connection to said first end connection bridge 66 and/or said second end connection bridge 67.

According to one embodiment, the first axial tie-rod 61 has a tangential bulk or tangential thickness 70 that is smaller than a spring thrust portion width 36 of said spring thrust portion 9. According to one embodiment, the first axial tie-rod 61 extends over said first elongated element 64 and said second elongated element 65 forming reinforcement ribs 72 in a reinforcement plane parallel to said axial direction A-A and said radial direction R-R.

According to one embodiment, the brake caliper 6 comprises a first axial tie-rod 61 and a second axial tie-rod 62 connecting said first elongated element 64 to said second elongated element 65 in the axial direction A-A. According to one embodiment, the strip spring 2 is hooked to said first axial tie-rod 61 and to said second axial tie-rod 62, avoiding connection to said first end connection bridge 66 and/or said second end connection bridge 67.

According to one embodiment, the first axial tie-rod 61 and the second axial tie-rod 62 have a tangential bulk or tangential thickness 70 that is smaller than a spring thrust portion width 36 of said spring thrust portion 9. According to one embodiment, the first axial tie-rod 61 and said second axial tie-rod 62 extend over said first elongated element 64 and said second elongated element 65 forming reinforcement ribs 72 in planes parallel to said axial direction A-A and said radial direction R-R. According to one embodiment, the tangential distance between said first axial tie-rod 61 and said second axial tie-rod 62 is between three times and one and a half times the spring thrust portion width 36 of the spring thrust portion 9. According to one embodiment, the brake caliper 16 comprises at least one strip spring and brake pad assembly 1.

According to one embodiment, the tangential tie-rod 63 is provided with shaped opposing seats to receive the end part of the coupling portion 8 of the strip spring 2. According to one embodiment, the brake caliper 16 comprises at least one strip spring and brake pad assembly 1. According to one embodiment, the tangential tie-rod 63 is provided with shaped opposing seats to receive the end part of the coupling portion 8 of the strip spring 2. According to one embodiment, the tangential tie-rod 63 comprises a shaped niche for undercut housing of the curled ends of the coupling portion 8, facilitating snap insertion of the spring onto the tangential tie-rod and ensuring a secure coupling that prevents accidental detachment of the spring from the caliper body 7.

According to a general embodiment, the invention relates to a brake pad 5 for a brake caliper 7. Said brake pad 5 defines an axial direction A-A, a radial direction R-R perpendicular to the axial direction A-A, and a circumferential direction C-C, perpendicular to both said axial direction A-A and said radial direction R-R. The brake pad 5 comprises a plate 10 and friction material 11 supported by the plate 10. The friction material 11 is suitable for contacting a braking surface 4 of a brake disc 3. Said brake disc 3 has a rotation axis X-X around which it rotates. The rotation axis X-X is parallel to the axial direction A-A. The plate 10 comprises a first tangentially outer edge 14 and a second tangentially outer edge 15 which are diametrically opposite or symmetrical with respect to a centerline plane A-R. Said centerline plane A-R is parallel to said axial direction A-A and said radial direction R-R. The plate 10 comprises a radially outer edge 16 and a radially inner edge 17. Said radially outer edge 16 faces at least partially along said radial direction R-R radially outward R-O, away from the rotation axis X-X. Said radially inner edge 16 faces at least partially along said radial direction R-R radially inward R-I, toward the rotation axis X-X. Said radially outer edge 16 comprises at least two thrust portions 12, 112 suitable to be contacted by at least two strip springs 2, 102 to each receive an elastic bias away from the brake disc 3. Each thrust portion 12 is delimited at least by a ramp 18. The ramp 18 is inclined at least with respect to the axial direction A-A and said radial direction R-R. Said ramp 18 faces the same side as the friction material 11. Said ramp 18 extends radially and axially away from said friction material 11 from a radially inner edge 19 to a radially outer edge 20. Said radially outer edge 20 extends at least in the radial direction R-R and at least in the tangential direction C-C equidistant from said centerline plane A-R relative to the symmetrical ramp 18. Said radially outer edge 20 comprises at least a first convex portion 21. Said first convex portion 21 forms a first concavity facing radially inward R-I. Said first convex portion 21 comprises a first central part 22, a first lateral part 23, and a second lateral part 24. The first central part 22 is interposed between the first lateral part 23 and the second lateral part 24, so that the strip spring 2 is adapted to apply said elastic bias at least partially on the first central part 22 of said first convex portion 21, influencing said brake pad 5 at least in retraction from said brake disc 3 in the axial direction A-A, avoiding contact with the first lateral part 23 and the second lateral part 24 of said first convex portion 21.

According to one embodiment, a strip spring and brake pad assembly for a brake caliper 6 is indicated by reference number 1.

Said assembly 1 defines an axial direction A-A, a radial direction R-R perpendicular to the axial direction A-A, and a circumferential direction C-C, perpendicular to both said axial direction A-A and said radial direction R-R. Within the present description, unless otherwise specified, the axial direction A-A, radial direction R-R, and circumferential direction C-C may also refer to directions coinciding with or parallel to them.

Said assembly 1 comprises a brake pad 5 comprising a plate 10 and friction material 11 supported by the plate 10. The friction material 11 is suitable for contacting a braking surface 4 of a brake disc 3. Said brake disc 3 has a rotation axis X-X around which it rotates, and the rotation axis X-X is parallel to the axial direction A-A.

The plate 10 comprises a first tangentially outer edge 14 and a second tangentially outer edge 15 which are diametrically opposite or symmetrical with respect to a centerline plane A-R. Said centerline plane A-R is parallel to said axial direction A-A and said radial direction R-R. According to one embodiment, said first tangentially outer edge 14 and said second tangentially outer edge 15 extend predominantly rectilinearly in the radial direction R-R.

The plate 10 comprises a radially outer edge 16 and a radially inner edge 17. Said radially outer edge 16 faces at least partially along said radial direction R-R radially outward R-O, away from the rotation axis X-X. Said radially inner edge 17 faces at least partially along said radial direction R-R radially inward R-I, toward the rotation axis X-X. Said radially outer edge 16 comprises a thrust portion 12.

According to one embodiment, said assembly 1 comprises a strip spring 2. The strip spring 2 comprises a coupling portion 8 configured to connect to a caliper body 7, at least one spring thrust portion 9 configured to contact said brake pad 5 at said thrust portion 12 to exert an elastic bias on said brake pad 5 to move it away from the brake disc 3, wherein the spring thrust portion 9 is connected to said coupling portion 8. According to one embodiment, the strip spring 2 is shaped to straddle the brake disc 2 to exert said elastic bias on said at least one brake pad 5 to influence it in retraction from said brake disc 2.

Said thrust portion 12 is delimited at least by a ramp 18. The ramp 18 is inclined at least with respect to the axial direction A-A and said radial direction R-R. Said ramp 18 faces the same side as the friction material 11.

Said ramp 18 extends radially and axially away from said friction material 11 between a radially inner edge 19 and a radially outer edge 20, wherein said radially outer edge 20 extends at least in the radial direction R-R and at least in the tangential direction C-C. In accordance with one embodiment, for example when a third strip spring 202 is provided, said ramp 18 extends radially and axially away from said friction material 11 between a radially inner edge 19 and a radially outer edge 20, wherein said radially outer edge 20 extends at least in the radial direction R-R and at least in the tangential direction C-C crossing said centerline plane A-R.

Advantageously, said radially outer edge 20 comprises at least a first convex portion 21. Said first convex portion 21 forms a first concavity facing radially inwards R-I. Said first convex portion 21 comprises a first central part 22, a first side part 23 and a second side part 24. The first central part 22 is interposed between the first side part 23 and the second side part 24.

Advantageously, the strip spring 2 is adapted to exert with said spring thrust portion 9 said elastic bias at least partially on the first central part 22 of said first convex portion 21, influencing said brake pad 5 at least in retraction from said brake disc 3 in the axial direction A-A, avoiding contact with the first side part 23 and the second side part 24 of said first convex portion 21.

Thanks to the assembly 1 according to the present invention, it is possible to limit as much as possible the contact zones between the strip spring 2 and the brake pad 5 so as to allow secure contact between the strip spring and the pad, and to allow retraction of the pad from the brake disc once the highly efficient braking action has ended.

In accordance with one embodiment, said radially outer edge 20 comprises at least a second convex portion 25 which forms a second concavity facing radially inwards R-I. In accordance with one embodiment, said radially outer edge 20 comprises at least one concave portion 29 which forms a third concavity facing radially outwards R-O. In accordance with one embodiment, said concave portion 29 is central with respect to said first convex portion 21 and said second convex portion 25, which are tangentially outside said concave portion 29.

In accordance with one embodiment, said spring thrust portion 9 exerts said elastic bias on said first convex portion 21 and on said second convex portion 25, influencing said brake pad 5 at least in retraction from said brake disc 3 in the axial direction A-A, avoiding contact with said concave portion 29.

In accordance with one embodiment, said second convex portion 25 comprises a second central part 26, a third side part 27 and a fourth side part 28, wherein the second central part 26 is interposed between the third side part 27 and the fourth side part 28.

In accordance with one embodiment, the strip spring 2 is adapted to exert with said spring thrust portion 9 said elastic bias at least partially on the second central part 26 of said second convex portion 25, influencing said brake pad 5 at least in retraction from said brake disc 4 in the axial direction A-A, avoiding contact with the third side part 27 and the fourth side part 28 of said second convex portion 25.

In accordance with one embodiment, said spring thrust portion 9 exerts said elastic bias on said first convex portion 21 and on said second convex portion 25, influencing said brake pad 5 at least in retraction from said brake disc 3 in the axial direction A-A, contacting exclusively said first convex portion 21 and said second convex portion 25, avoiding contact elsewhere on said brake pad 5 by said spring thrust portion 9.

Thanks to the strip spring and brake pad assembly 1, it is possible to realize exclusively two contact and sliding zones between the brake pad and the strip spring, to allow retraction of the brake pad once the braking action has ended.

In accordance with one embodiment, the strip spring 2 is adapted to exert with said spring thrust portion 9 said elastic bias on the brake pad 5, influencing said brake pad 5 at least in retraction from said brake disc 4 in the axial direction A-A, and influencing said brake pad 5 in the radial direction R-R.

In accordance with one embodiment, for example when a third strip spring 202 is provided, said concave portion 29 is radially internal with respect to said first convex portion 21 and said second convex portion 25, wherein said concave portion 29 crosses said centerline plane A-R.

In accordance with one embodiment, said concave portion 29 is radially internal with respect to said first convex portion 21 and said second convex portion 25. In accordance with one embodiment, said concave portion 29 crosses said centerline plane A-R.

In accordance with one embodiment, said radially outer edge 20 extends along a longitudinal direction of edge G-G that has centrally a U-shape, at least partially inclined both with respect to said radial direction R-R and said circumferential direction C-C, and laterally is rectilinear, parallel to said circumferential direction C-C.

In accordance with one embodiment, said spring thrust portion 9 comprises a first spring edge 30 and a second spring edge 31, which are tangentially opposite to each other. In accordance with one embodiment, said spring thrust portion 9 contacts said first convex portion 21 with said first spring edge 30 and said second convex portion 25 with said second spring edge 31.

In accordance with one embodiment, said spring thrust portion 9 comprises a radially inner face 32 facing radially inward R-I toward said brake pad 5. In accordance with one embodiment, said radially inner face 32 extends along said circumferential direction C-C between a first spring edge 33 and a second spring edge 34. In accordance with one embodiment, said spring thrust portion 9 contacts said first convex portion 21 with said first spring edge 33 and said second convex portion 25 with said second spring edge 34. In accordance with one embodiment, said first spring edge 33 and said second spring edge 34 are chamfered.

In accordance with one embodiment, said spring thrust portion 9 comprises a thrust end 35 configured to contact said brake pad 5, wherein said thrust end 35 defines a spring thrust portion width 36. In accordance with one embodiment, said spring thrust portion 9 comprises a thrust end 35 configured to contact said brake pad 5, wherein said thrust end 35 defines a spring thrust portion width 36. In accordance with one embodiment, between said second side part 24 of said first convex portion 21 and said fourth side part 28 of said second convex portion 25 a first tangential distance runs along said circumferential direction C-C or a direction parallel thereto. In accordance with one embodiment, between said first side part 23 of said first convex portion 21 and said third side part 27 of said second convex portion 25 there is a second tangential distance along said circumferential direction C-C or a direction parallel thereto. In accordance with one embodiment, said spring thrust portion width 36 is greater than said first tangential distance and is less than said second tangential distance so that said thrust end 35 interferes with said first central part 22 and said second central part 27, self-centering with respect to said thrust portion 12. In accordance with one embodiment, said spring thrust portion width 36 is equal to a central tangential distance that occurs along said circumferential direction C-C between said first central part 22 and said second central part 27 so that said spring thrust portion 9 self-centers on said thrust portion 12.

Thanks to the contact between only two tangentially opposite zones of the spring thrust portion 9 and the thrust portion 12 of the brake pad, it is possible to obtain a strip spring that is self-centering on the brake pad, allowing an extremely simplified assembly.

Furthermore, thanks to the contact between only two tangentially opposite zones of the spring thrust portion 9 and the thrust portion 12 of the brake pad, it is possible to allow planar retraction of the brake pad, avoiding portions of the friction material being worn differently during retraction of the brake pad.

In accordance with one embodiment, the first central part 22 is radially external with respect to said first side part 23 and said second side part 24. In accordance with one embodiment, for example when a third strip spring 202 is provided, said first central part 22 is crossed by said centerline plane A-R. In accordance with one embodiment, said first central part 22 is crossed by said centerline plane A-R. In accordance with one embodiment, said first central part 22 forms a radially outer apical portion of said radially outer edge 20. In accordance with one embodiment, said first central part 22 is the most radially external portion of said radially outer edge 20.

According to an embodiment, the strip spring 2 is suitable for exerting said elastic action with said spring thrust portion 9 exclusively on the first central part 22 of said first convex portion 21, influencing said brake pad 5 at least in withdrawal from said brake disc 3 in axial direction A-A and radial direction R-R.

According to an embodiment, said radially outer edge 20 comprises two concave portions 29 tangentially opposed with respect to said at least one first convex portion 21, wherein said first convex portion 21 is radially external with respect to said two concave portions 29. The strip spring 2 is suitable for exerting said elastic action with said spring thrust portion 9 on the first convex portion 21, avoiding contact with said two concave portions 29.

According to an embodiment, said spring thrust portion 9 comprises a thrust end 35 configured to contact said brake pad 5. Said thrust end 35 defines a thrust portion width 36. Each concave portion 29 of said two concave portions 29 has a substantially U-shape. Each concave portion 29 has a radial minimum, wherein between the radial minima of the two concave portions 29 a concave portions distance is defined, wherein said thrust portion width 36 is substantially equal to said concave portions distance.

Thanks to the provision of the thrust portion 12 of the brake pad 5 which comprises a central convex portion that forms a radially outer maximum of the thrust portion 12, it is possible to limit the contact between the strip spring 2 and the brake pad to a single contact and sliding area, allowing excellent mutual contact and positioning of the leaf spring and the pad, allowing an extremely responsive withdrawal of the pad from the disc as soon as the braking action is finished.

According to an embodiment, said backing plate 10 comprises a free front surface 37 around the friction material 11. The free front surface 37 faces the same side as the friction material 10.

According to an embodiment, said backing plate 10 comprises a back 38 delimiting the backing plate 10 on the side axially opposite to the friction material 11. Said back 38 is suitable for facing pushing elements 45 of the brake caliper 6.

According to an embodiment, said radially inner edge 19 is defined by the intersection of said ramp 18 and said free front surface 37.

According to an embodiment, said thrust portion 12 is delimited by an axial edge 39 that extends along said axial direction A-A between said ramp 18 and said back 38. According to an embodiment, said axial edge 39 extends linearly parallel to the axial direction A-A.

According to an embodiment, said radially outer edge 20 is defined by the intersection of said ramp 18 with said axial edge 39.

According to an embodiment, said spring thrust portion 9 comprises a thrust end 35 suitable for contacting said brake pad 5, wherein said thrust end 35 is bent with respect to said radial direction R-R in a direction opposite to said brake pad 5 by a spring angle, and wherein said ramp 18 is inclined with respect to said radial direction R-R by a ramp angle, wherein said ramp angle is smaller than said spring angle so as to avoid contact between said ramp 18 and said strip spring 2.

According to an embodiment, said radially inner edge 19 extends along a longitudinal direction parallel to the development direction of the radially outer edge 20.

According to an embodiment, said backing plate 10 comprises a reference portion 13. According to an embodiment, said axial edge 38 forms said reference portion 13.

According to an embodiment, said strip spring 2 comprises an abutment portion 68 suitable for abutting against the reference portion 13, forming a support on an area of said reference portion 13 that prevents any slipping of said spring thrust portion 9 when the strip spring 2 is subject to external forces. According to an embodiment, said abutment portion 68, when resting against said reference portion 13, is subjected to bending. According to an embodiment, said abutment portion 68 extends in cantilever fashion from the spring body 46.

According to an embodiment, in working condition, the abutment portion 68 never contacts the reference portion 13. According to an embodiment, as the friction material wears, the abutment portion 68 tends to move away from the reference portion 13.

According to an embodiment, said backing plate 11 defines a spring seat 40 suitable for receiving said spring thrust portion 9. Said spring seat 40 passes through at least one thickness of the backing plate. Said backing plate 11 comprises a first lateral wall 41 and a second lateral wall 42 which are connected to said thrust portion 12 and extend from said thrust portion 12 at least in the radial direction R-R, tangentially delimiting said spring seat 40 from opposite sides. According to an embodiment, said spring seat 40 is delimited by said thrust portion 12 along said radial direction R-R in the radially inner direction R-I.

According to an embodiment, said spring seat 40 is open in the radial direction R-R in the radially outer direction R-O.

According to an embodiment, said spring seat 40 is closed by a radially inner wall 43 facing in the radially inner direction R-I.

According to an embodiment, said spring seat 40 is closed by said radially inner wall 43 facing in the radially inner direction R-I, wherein said spring seat 40 passes through the brake pad 5 in such a way as to position said thrust portion 12 near a center of mass of the friction material 10.

Thanks to the positioning of the thrust portion 12 of the brake pad 5 near the center of mass or thrust center of the brake pad 5, it is possible to apply the elastic force of the spring at the center of the braking band of the disc, allowing an extremely balanced retraction of the brake pad. Moreover, it is possible to minimize deformation of the pad as much as possible.

According to an embodiment, said strip spring 2 comprises a spring body 46.

According to an embodiment, said coupling portion 8 comprises at least a first hooking arm 47 and a second hooking arm 48 configured to secure the strip spring 2 to the caliper body 6. Each hooking arm 47, 48 extends from a central spring portion 50 to a respective hooking end 49.

According to an embodiment, said first hooking arm 47 and said second hooking arm 48 are bent substantially in a U-shape.

According to an embodiment, said strip spring 2 comprises at least a first thrust arm 51 extending from the central spring portion 50 to the spring thrust portion 9. According to an embodiment, the spring thrust portion 9 has a respective thrust end 35. According to an embodiment, said at least one first thrust arm 51 is shaped with two branches bent in a U or V shape.

According to an embodiment, the first thrust arm 51 comprises a first flat thrust section 54 extending mainly along said axial direction A-A, a second flat thrust section 55 connected to said first flat thrust section 54 through a first curved thrust section 52 such that the second flat thrust section 55 is inclined relative to the radial direction R-R and bent toward the central spring portion 50, and a third flat thrust section 56 connected to said second flat thrust section 55 through a second curved thrust section 53 such that the third flat thrust section 56 is inclined relative to the radial direction R-R and bent toward the central spring portion 50.

According to an embodiment, said abutment portion 68 extends in cantilever fashion from said first thrust arm 51, moving away from said spring thrust portion 9.

According to an embodiment, said strip spring 2 is obtained from a sheared, shaped, and bent sheet of predetermined spring thickness, forming a spring strip.

According to an embodiment, the coupling portion 8 and the spring thrust portion 9 are bent in orthogonal bending planes.

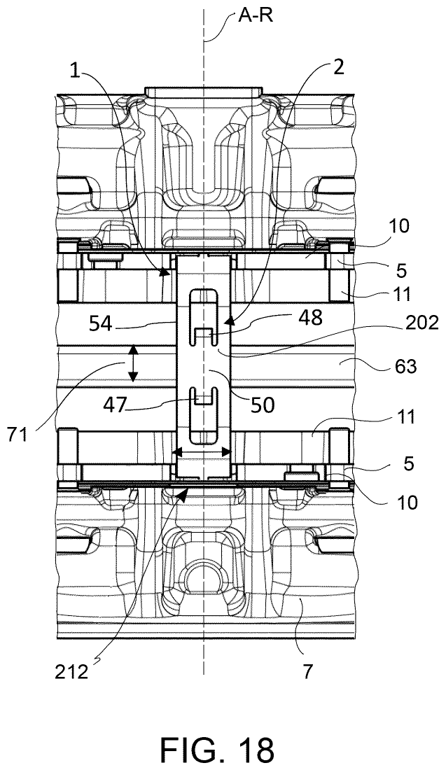

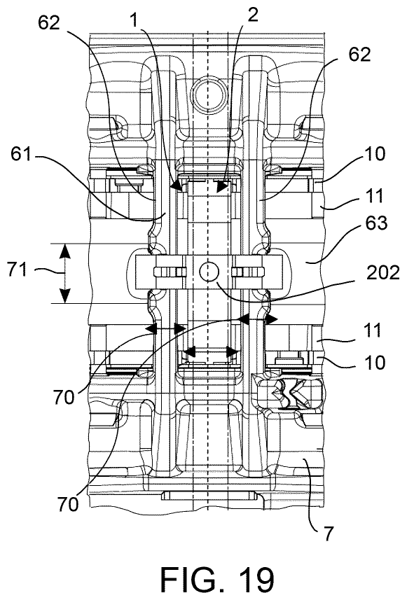

According to an embodiment, the coupling portion 8 is made in one piece with the spring thrust portion 9. For example, the coupling portion 8 is made as a tab in the spring body 46, where the tab is in a lateral position relative to the thrust portion 9, or as in FIG. 18, where the tab is made in the strip body of the thrust portion 9 leaving a tab opening.

According to an embodiment, the coupling portion 8 and the spring thrust portion 9 are bent in coincident or parallel bending planes. According to an embodiment, the first hooking arm 47 and the second hooking arm 48 are configured to embrace a tangential tie rod 63 that is parallel to the brake disc 3. According to an embodiment, the leaf spring comprises the first hooking arm 47 and the second hooking arm 48, without additional hooking arms when the brake pad has a thrust portion provided with two support zones, allowing a self-centering coupling between the leaf spring and the brake pad.

According to an embodiment, said strip spring 2 comprises a first spring strip 57 and a second spring strip 58 connected to each other at the central spring portion 50, wherein the first spring strip 57 forms the spring thrust portion 9 and the second spring strip 58 forms the coupling portion 8.

According to an embodiment, said coupling portion 8 comprises a third hooking arm 59 and a fourth hooking arm 60. According to an embodiment, said third hooking arm 59 cooperates with said first hooking arm 47 to constrain the strip spring 2 to a first axial tie rod 61 of the caliper body 6 positioned astride the brake disc 3, and said fourth hooking arm 60 cooperates with said second hooking arm 48 to constrain the strip spring 2 to a second axial tie rod 62 of the caliper body 6 also positioned astride the brake disc 3. In this way, it is possible to center the strip spring 2 relative to the thrust portion 12 of the brake pad, which has a single convex portion that forms a radially outermost maximum and allows for only one contact zone between the brake pad 5 and the strip spring 2.

According to an embodiment, said coupling portion 8 and said spring thrust portion 9 extend along mutually orthogonal directions. According to an embodiment, between said first axial tie rod 61 and said second axial tie rod 62 a tangential distance of axial tie rods is defined, where the tangential distance is measured either with respect to the center of each axial tie rod 61, 62 or between respective faces or edges of said axial tie rods 61, 62 that face each other along the circumferential direction C-C. According to an embodiment, the tangential distance of axial tie rods ranges between three times and one and a half times the thrust portion width 36 of the spring thrust portion 9. According to an embodiment, the minimum tangential distance of axial tie rods is equal to the thrust portion width 36.

The present invention also relates to a brake caliper referred to by reference number 6.

The brake caliper 6 comprises a caliper body 7 suitable to straddle a brake disc 3. Said caliper body 7 includes a first elongated element 64, a second elongated element 65, a first connecting bridge 66 and a second connecting bridge 67 that tangentially connect said first elongated element 64 and said second elongated element 65 from opposite sides.

The brake caliper 6 includes an assembly of leaf spring and pad 1 according to any of the previously described embodiments.

Said brake pad 5 is directly or indirectly supported by said caliper body 7 and housed within said caliper body 7.

The brake caliper 6 comprises thrust elements or pistons 45 housed in said first elongated element 64 and/or in said second elongated element 65 to act on at least said brake pad 5 toward the brake disc 3.

According to an embodiment, said brake caliper 6 comprises a first axial tie rod 61 and a second axial tie rod 62 that connect said first elongated element 64 to said second elongated element 65 in the axial direction A-A, wherein said strip spring 2 is hooked, preferably in an undercut manner, to said first axial tie rod 61 and to said second axial tie rod 62, avoiding attachment to said first connecting bridge 66 and/or said second connecting bridge 67.

According to an embodiment, said first axial tie rod 61 and said second axial tie rod 62 have a tangential axial tie rod dimension or tangential thickness of axial tie rod 70 that is smaller than a thrust portion width 36 of said thrust portion 9. According to an embodiment, each tangential axial tie rod dimension or thickness is measured as the distance between two tangentially opposite faces of the respective axial tie rod 61, 62, preferably between the points where the opposite faces are farthest apart.

According to an embodiment, said first axial tie rod 61 and said second axial tie rod 62 extend over said first elongated element 64 and said second elongated element 65, forming reinforcement ribs 72 in reinforcement planes parallel to said axial direction A-A and said radial direction R-R.

According to an embodiment, said brake caliper 6 includes a tangential tie rod 63 that connects said first connecting bridge 66 to said second connecting bridge 67 along said circumferential direction C-C, overhanging said brake disc 3, wherein said strip spring 2 is hooked to said tangential tie rod 63, preferably in an undercut manner.

According to an embodiment, said tangential tie rod 63 has an axial dimension or axial thickness of tangential tie rod 71 that is smaller than a thrust portion width 36 of said thrust portion 9. According to an embodiment, the axial dimension or thickness is measured as the distance between two axially opposite faces of said tangential tie rod 63, preferably between the points where the opposite faces are farthest apart.

The present invention also relates to a brake pad referred to by reference number 5. Said brake pad 5 defines an axial direction A-A, a radial direction R-R perpendicular to the axial direction A-A, and a circumferential direction C-C, which is perpendicular to both the axial direction A-A and the radial direction R-R.

Said brake pad 5 includes a backing plate 10 and a friction material 11 supported by the backing plate 10, wherein the friction material 11 is suitable to contact a braking surface 4 of a brake disc 3, wherein said brake disc 3 has a rotation axis X-X around which it rotates, and said rotation axis X-X is parallel to the axial direction A-A.

The backing plate 10 includes a first tangentially outer edge 14 and a second tangentially outer edge 15 which are diametrically opposed or symmetrical with respect to a mid-plane A-R, wherein said mid-plane A-R is parallel to said axial direction A-A and said radial direction R-R.

The backing plate 10 includes a radially outer edge 16 and a radially inner edge 17, wherein said radially outer edge 16 faces at least partially along said radial direction R-R toward radially outer direction R-O, moving away from the rotation axis X-X, and said radially inner edge 17 faces at least partially along said radial direction R-R toward radially inner direction R-I, approaching the rotation axis X-X.

Said radially outer edge 16 comprises a thrust portion 12 which is suitable to be contacted by a strip spring 2 to receive an elastic action that moves it away from the brake disc 3. Said thrust portion 12 is delimited at least by a ramp 18, where the ramp 18 is inclined at least with respect to the axial direction A-A and said radial direction R-R, and said ramp 18 faces the same side as the friction material 11. Said ramp 18 extends radially and axially away from said friction material 11, between a radially inner edge 19 and a radially outer edge 20. Said radially outer edge 20 comprises at least a first convex portion 21, where said first convex portion 21 forms a first concavity facing radially inward R-I. Said first convex portion 21 comprises a first central part 22, a first lateral part 23, and a second lateral part 24, where the first central part 22 is interposed between the first lateral part 23 and the second lateral part 24, such that the strip spring 2 is suitable to exert said elastic action at least partially on the first central part 22 of said first convex portion 21, influencing said brake pad 5 at least to move away from said brake disc 3 in the axial direction A-A, while avoiding contact with the first lateral part 23 and the second lateral part 24 of said first convex portion 21.

According to an embodiment, said brake pad 5 is the brake pad of said leaf spring and pad assembly 1, as previously described.

### REFERENCE LIST

1 Strip spring and brake pad assembly
2 Strip spring
3 Brake disc
4 Braking surface
5 Brake pad
6 Brake caliper
7 Caliper body
8 Coupling portion
9 Spring thrust portion
10 Plate
11 Friction material
12 Thrust portion
13 Abutment portion
14 First tangentially outer edge
15 Second tangentially outer edge
16 Radially outer edge
17 Radially inner edge
18 Ramp
19 Radially inner edge
20 Radially outer edge
21 First convex portion
22 First central part
23 First side part
24 Second side part
25 Second convex portion
26 Second central part
27 Third side part
28 Fourth side part
29 Concave portion
30 First spring edge
31 Second spring edge
32 Radially inner face
33 First spring edge or first radially inner edge of thrust portion
34 Second spring edge or second radially inner edge of thrust portion
35 Thrust end
36 Thrust portion width
37 Front free surface of the plate
38 Back of the plate
39 Axial edge
40 Spring seat
41 First side seat wall
42 Second side seat wall
43 Radially inner wall
44 Plate thickness
45 Thrust elements or pistons
46 Spring body
47 First coupling arm
48 Second coupling arm
49 Coupling end
50 Central spring portion
51 First thrust arm
52 First curved thrust section
53 Second curved thrust section
54 First flat thrust section
55 Second flat thrust section
56 Third flat thrust section
57 First spring strip of spring body
58 Second spring strip of spring body
59 Third coupling arm
60 Fourth coupling arm
61 First axial tie-rod
62 Second axial tie-rod
63 Tangential tie-rod
64 First elongated element
65 Second elongated element
66 First connection bridge
67 Second connection bridge
68 Abutment portion
69 Brake pad support and sliding pins
102 Second strip spring
112 Second thrust portion
202 Third strip spring
212 Third thrust portion
X-X Rotation axis
A-A Axial direction
R-R Radial direction
C-C Circumferential direction
T-T Circumferential direction
A-R Centerline plane
R-Radially inwards
R-O Radially outwards
G-G Longitudinal direction of the edge
E Spring angle
F Ramp angle
DIS Predefined distance between strip spring and centerline plane or between thrust portion and centerline plane

What is claimed is:

1. A strip spring and brake pad assembly (1) for a brake caliper (6),
wherein said assembly (1) defines an axial direction (A-A), a radial direction (R-R) perpendicular to the axial direction (A-A), and a circumferential direction (C-C) perpendicular to both said axial direction (A-A) and said radial direction (R-R),
wherein said assembly (1) comprises:
a brake pad (5) comprising a plate (10) and a friction material (11) supported by the plate (10), wherein the friction material (11) is adapted to press against a braking surface (4) of a brake disc (3), wherein said brake disc (3) has a rotation axis (X-X) about which it rotates, wherein the rotation axis (X-X) is parallel to the axial direction (A-A),
wherein the plate (10) comprises a first tangentially outer edge (14) and a second tangentially outer edge (15), which are diametrically opposite or specular with respect to a centerline plane (A-R), wherein said centerline plane (A-R) is parallel to said axial direction (A-A) and said radial direction (R-R),
wherein the plate (10) comprises a radially outer edge (16) and a radially inner edge (17),
wherein said radially outer edge (16) faces at least partially along said radial direction (R-R) radially outwards (R-O) away from the rotation axis (X-X), wherein said radially inner edge (17) faces at least partially along said radial direction (R-R) radially inwards (R-I) towards the rotation axis (X-X),
wherein said radially outer edge (16) comprises at least two thrust portions (12, 112),
wherein said assembly (1) comprises:
at least two strip springs (2, 102), each comprising a coupling portion (8) configured to connect to a caliper body (7), at least one spring thrust portion (9) configured to contact said brake pad (5) at said thrust portion (12) to apply an elastic bias to said brake pad (5) to move it away from the brake disc (3), wherein the spring thrust portion (9) is connected to said coupling portion (8),
wherein each of said at least two thrust portions (12, 112) is delimited at least by a ramp (18), wherein the ramp (18) is inclined at least with respect to the axial direction (A-A) and said radial direction (R-R), wherein said ramp (18) faces the same side as the friction material (11),
wherein said ramp (18) extends radially and axially away from said friction material (11) between a radially inner edge (19) to a radially outer edge (20),
wherein said radially outer edge (20) extends at least in the radial direction (R-R) and at least in the circumferential direction (C-C);
wherein two of said at least two strip springs (2, 102) are arranged on opposite sides of said centerline plane (A-R) at predefined distances (DIS) mutually equal and specular with respect to said centerline plane (A-R), and wherein two of said at least two thrust portions (12, 112) are arranged on opposite sides of said centerline plane (A-R), at predefined distances (DIS) mutually equal and specular with respect to said centerline plane (A-R),
wherein said radially outer edge (20) of each of said at least two thrust portions (12, 112) comprises at least a first convex portion (21), wherein said first convex portion (21) forms a first concavity facing radially inwards (R-I), wherein said first convex portion (21) comprises a first central part (22), a first side part (23), and a second side part (24), wherein the first central part (22) is interposed between the first side part (23) and the second side part (24),
wherein each strip spring (2, 102) is adapted to apply, with said spring thrust portion (9), said elastic bias at least partially to the first central part (22) of said first convex portion (21), so that two spring thrust portions (9) of said at least two strip springs (2, 102) bias said brake pad (5) at least away from said brake disc (3) in an axial direction (A-A), avoiding contacting the first side part (23) and the second side part (24) of said first convex portion (21) and applying biases parallel to each other and substantially equally spaced apart from said centerline plane (A-R).

2. A strip spring and brake pad assembly (1) according to claim 1,
wherein said radially outer edge (20) comprises at least a second convex portion (25), which forms a second concavity facing radially inwards (R-I),
wherein said radially outer edge (20) comprises at least one concave portion (29), which forms a third concavity facing radially outwards (R-O),
wherein said concave portion (29) is central with respect to said first convex portion (21) and said second convex portion (25),
wherein said spring thrust portion (9) applies said elastic bias to said first convex portion (21) and said second convex portion (25), biasing said brake pad (5) at least away from said brake disc (3) in the axial direction (A-A), avoiding contacting said concave portion (29).

3. A strip spring and brake pad assembly (1) according to claim 2, comprising at least one of the following features:
wherein said second convex portion (25) comprises a second central part (26), a third side part (27), and a fourth side part (28), wherein the second central part (26) is interposed between the third side part (27) and the fourth side part (28),
wherein the strip spring (2) is adapted to apply, with said spring thrust portion (9), said elastic bias at least partially to the second central part (26) of said second convex portion (25), biasing said brake pad (5) at least away from said brake disc (4) in the axial direction (A-A), avoiding contacting the third side part (27) and the fourth side part (28) of said second convex portion (25),
and/or wherein said spring thrust portion (9) applies said elastic bias to said first convex portion (21) and said second convex portion (25), biasing said brake pad (5) at least away from said brake disc (3) in the axial direction (A-A) and in the radial direction (R-R), contacting exclusively said first convex portion (21) and said second convex portion (25) avoiding contacting said brake pad (5) elsewhere with said spring thrust portion (9), and/or wherein said concave portion (29) is radially internal with respect to said first convex portion (21) and said second convex portion (25), wherein said concave portion (29), in said at least two ramps (18), is arranged equally spaced apart from said centerline plane (A-R).

4. A strip spring and brake pad assembly (1) according to claim 3, comprising one or more of the following features:
wherein said spring thrust portion (9) comprises a first spring edge (30) and a second spring edge (31), tangentially opposite to each other, wherein said spring thrust portion (9) contacts said first convex portion (21) with said first spring edge (30) and said second convex portion (25) with said second spring edge (31),
and/or wherein said spring thrust portion (9) comprises a radially inner face (32) facing radially inwards (R-I) towards said brake pad (5),
wherein said radially inner face (32) extends along said circumferential direction (C-C) between a first spring edge (33) and a second spring edge (34),
wherein said spring thrust portion (9) contacts said first convex portion (21) with said first spring edge (33) and said second convex portion (25) with said second spring edge (34), and/or wherein said spring thrust portion (9) comprises a thrust end (35) configured to contact said brake pad (5), wherein said thrust end (35) defines a thrust portion width (36),
wherein between said second side part (24) of said first convex portion (21) and said fourth side part (28) of said second convex portion (25) there is a first tangential distance along said circumferential direction (C-C) or a direction parallel thereto,
wherein between said first side part (23) of said first convex portion (21) and said third side part (27) of said second convex portion (25) there is a second tangential distance along said circumferential direction (C-C) or a direction parallel thereto,
wherein said thrust portion width (36) is greater than said first tangential distance and is smaller than said second interference distance so that said thrust end (35) interferes with said first central part (22) and said second central part (27), self-centering with respect to said thrust portion (12).

5. A strip spring and brake pad assembly (1) according to claim 1,
wherein the first central part (22) is radially external with respect to said first side part (23) and said second side part (24),
wherein said first central part (22) is crossed by a plane parallel to said centerline plane (A-R) with respect to said axial direction (A-A),
wherein said first central part (22) forms a radially outer apical portion of said radially outer edge (20), wherein said first central part (22) is the radially outermost portion of said radially outer edge (20),
wherein the strip spring (2) is adapted to apply, with said spring thrust portion (9), said elastic bias exclusively to the first central part (22) of said first convex portion (21), biasing said brake pad (5) at least away from said brake disc (3) in the axial (A-A) and radial (R-R) directions.

6. A strip spring and brake pad assembly (1) according to claim 1, comprising one or more of the following features:
wherein said first convex portion (21) is a curved portion of said thrust portion (12) which forms a radially outer maximum of said thrust portion (12),
and/or wherein said radially outer edge (20) comprises two concave portions (29) tangentially opposite with respect to said at least a first convex portion (21), wherein said first convex portion (21) is radially outer with respect to said two concave portions (29)
wherein the strip spring (2) is adapted to apply, with said spring thrust portion (9), said elastic bias to the first convex portion (21), avoiding contacting said two concave portions (29).

7. A strip spring and brake pad assembly (1) according to claim 1,
wherein said plate (10) comprises a free front surface (37) about the friction material (11),
wherein the front free surface (37) faces the same side as the friction material (11),
wherein said plate (10) comprises a back (38) which delimits the plate (10) on the side axially opposite to the friction material (11), wherein said back (38) is adapted to face at least one thrust element (45) of the brake caliper (6),
wherein said radially inner edge (19) is defined by the intersection of said ramp (18) and said free front surface (37),
wherein said thrust portion (12) is delimited by an axial edge (39) which extends along said axial direction (A-A) between said ramp (18) and said back (38),
wherein said radially outer edge (20) is defined by the intersection of said ramp (18) with said axial edge (39),
wherein said spring thrust portion (9) comprises a thrust end (35) adapted to contact said brake pad (5), wherein said thrust end (35) is bent with respect to said radial direction (R-R) in the opposite direction with respect to said brake pad (5) by a spring angle (E), and
wherein said ramp (18) is inclined with respect to said radial direction (R-R) by a ramp angle (F), wherein said ramp angle (F) is smaller than said spring angle (E) so as to prevent a contact between said ramp (18) and said strip spring (2).

8. A strip spring and brake pad assembly (1) according to claim 1, wherein said plate (11) defines a spring seat (40) adapted to accommodate said spring thrust portion (9),
wherein said spring seat (40) passes through at least one plate thickness,
wherein said plate (11) comprises a first side seat wall (41) and a second side seat wall (42) that are connected to said thrust portion (12) and extend from said thrust portion (12) at least in the radial direction (R-R) tangentially delimiting said spring seat (40) in opposite sides,
wherein said spring seat (40) is delimited by said thrust portion (12) along said radial direction (R-R) radially inwards (R-I),
wherein said spring seat (40) is open in the radial direction (R-R) radially outwards (R-O) or is closed by a radially inner wall (43) facing radially inwards (R-I), in said spring seat (40) the brake pad (5) passes through so as to arrange said thrust portion (12) close to a center of gravity of the friction material (10) or a thrust center of the brake pad (5).

9. A strip spring and brake pad assembly (1) according to claim 1, comprising one or more of the following features:
said strip spring (2) comprises a spring body (46);
wherein said coupling portion (8) comprises at least a first coupling arm (47) and a second coupling arm (48) configured to couple the strip spring (2) to the caliper body (6);
wherein each coupling arm (47, 48) extends from a central spring portion (50) to a respective coupling end (49);
wherein said first coupling arm (47) and said second coupling arm (48) are substantially U-bent;
wherein said strip spring (2) comprises at least a first thrust arm (51) which extends from the central spring portion (50) to the spring thrust portion (9), wherein the spring thrust portion (9) has a respective thrust end (35).

10. A strip spring and brake pad assembly (1) according to claim 1, comprising one or more of the following features:
wherein said strip spring (2) is obtained from a shaped and bent blanked sheet of predetermined spring thickness forming a spring strip;
wherein the coupling portion (8) is made in one piece with the spring thrust portion (9), for example the coupling portion (8) is made as a tab in the spring body (46);
wherein the coupling portion (8) and the spring thrust portion (9) are bent on coincident or parallel bending planes;
wherein the first coupling arm (47) and the second coupling arm (48) are configured to embrace a tangential tie-rod (63), which is parallel to the brake disc (3);
or
wherein said strip spring (2) comprises a first spring strip (57) and a second spring strip (58) connected to each other at the central spring portion (50);
wherein the first spring strip (57) forms the spring thrust portion (9) and wherein the second spring strip (58) forms the coupling portion (8);
or
wherein said radially outer edge (16) comprises at least three thrust portions (12, 112, 212), and wherein
said assembly (1) comprises at least three strip springs (2, 102, 202) as defined in claim 1;
wherein two of said at least three strip springs (2, 102, 202) are arranged on opposite sides of said centerline plane (A-R) at predefined distances (DIS) mutually equal and specular with respect to said centerline plane (A-R), and wherein two of said at least three thrust portions (12, 112, 212) are arranged on opposite sides of said centerline plane (A-R), at predefined distances (DIS) mutually equal and specular with respect to said centerline plane (A-R);
and wherein the third of said at least three strip springs (2, 102, 202) is arranged so as to cross said centerline plane (A-R); and wherein the third of said at least three thrust portions (12, 112, 212) is arranged so as to cross said centerline plane (A-R),
or
wherein the strip spring is made in two parts, each with a different elastic feature, wherein the coupling portion (8) is more flexible than the spring thrust portion (9);
or
wherein the two parts of the strip spring exhibit a different electrochemical potential feature, making the coupling portion (8) more compatible with the caliper body (7) to which it is hooked,
and/or wherein
the strip spring (2) comprises a coupling portion (8) and a spring thrust portion (9), wherein the two portions are made in one piece or are alternately connected to each other by riveting, cold mechanical joining (referred to as TOX), or welding;
and/or wherein
the strip spring (2) comprises a coupling portion (8) and a spring thrust portion (9), wherein the two portions are made in two pieces of different thickness, wherein the coupling portion (8) has a smaller thickness than the spring thrust portion (9), allowing the creation of low mounting forces and high forces which bias the brake pad (5);
and/or wherein
the strip spring (2) comprises a coupling portion (8) and a spring thrust portion (9), wherein both portions are in the shape of a strip or one of the two portions consists of a wire spring;
and/or wherein
the strip spring (2) comprises a coupling portion (8) and a spring thrust portion (9), wherein the coupling portion (8) is shaped with ends provided with radial curls, taking a toroidal or cylindrical configuration, where the radial shape is designed to facilitate the installation of the spring on the caliper body (7), providing a curved surface which slides easily over the caliper body and preventing any blockages or frictions.

11. A brake caliper (6) comprising a caliper body (7) adapted to straddle a brake disc (3), wherein said caliper body (7) comprises a first elongated element (64), a second elongated element (65), a first end connection bridge (66), and a second end connection bridge (67) which connect said first elongated element (64) and said second elongated element (65) from tangentially opposite sides,
at least one strip spring and pad assembly (1) according to claim 1, wherein said brake pad (5) is supported by said caliper body (7) and housed in said caliper body (7), at least one thrust element or piston (45) housed in said first elongated element (64) and/or in said second elongated element (65) to bias said at least one brake pad (5) towards the brake disc (3).

12. A brake caliper (6) according to claim 11, comprising one or more of the following features:
said brake caliper (6) comprises a tangential tie-rod (63) which connects said first connection bridge (66) to said second connection bridge (67) along said circumferential direction (C-C) above said brake disc (3), wherein said at least two strip springs (2, 102) are hooked to said tangential tie-rod (63) on opposite sides with respect to said centerline plane (A-R) and mutually equally spaced apart from said centerline plane (A-R);
and/or wherein said tangential tie-rod (63) has an axial tangential tie-rod dimension or axial tangential tie-rod thickness (71) which is smaller than a thrust portion width (36) of said thrust portion (9).

13. A brake caliper (6) according to claim 11, comprising one or more of the following features:
wherein said radially outer edge (16) comprises at least three thrust portions (12, 112, 212), and wherein
said assembly (1) comprises at least three strip springs (2, 102, 202);
wherein two of said at least three strip springs (2, 102, 202) are arranged on opposite sides of said centerline plane (A-R) at predefined distances (DIS) mutually equal and specular with respect to said centerline plane (A-R), and wherein two of said at least three thrust portions (12, 112, 212) are arranged on opposite sides of said centerline plane (A-R), at predefined distances (DIS) mutually equal and specular with respect to said centerline plane (A-R);
and wherein the third of said at least three strip springs (2, 102, 202) is arranged so as to cross said centerline plane (A-R); and wherein the third of said at least three thrust portions (12, 112, 212) is arranged so as to cross said centerline plane (A-R)
and wherein
said brake caliper (6) comprises at least a first axial tie-rod (61) which connect said first elongated element (64) to said second elongated element (65) in the axial direction (A-A), wherein the third of said strip springs (2) is hooked to said first axial tie-rod (61), avoiding coupling to said first connection bridge (66) and/or said second connection bridge (67),
or
and/or wherein said first axial tie-rod (61) has a tangential axial tie-rod dimension or tangential axial tie-rod thickness (70) which is smaller than a thrust portion width (36) of said thrust portion (9);
or
wherein said first axial tie-rod (61) extends over said first elongated element (64) and said second elongated element (65) forming reinforcing ribs (72) in a reinforcing plane parallel to said axial direction (A-A) and said radial direction (R-R).

14. A brake caliper (6) according to claim 11, comprising one or more of the following features:
said brake caliper (6) comprises a first axial tie-rod (61) and a second axial tie-rod (62) which connect said first elongated element (64) to said second elongated element (65) in the axial direction (A-A), wherein said strip spring (2) is hooked to said first axial tie-rod (61) and said second axial tie-rod (62), avoiding coupling to said first connection bridge (66) and/or said second connection bridge (67),
and/or wherein
wherein said first axial tie-rod (61) and said second axial tie-rod (62) have a tangential axial tie-rod dimension or tangential axial tie-rod thickness (70) which is smaller than a thrust portion width (36) of said thrust portion (9);
and/or wherein
said first axial tie-rod (61) and said second axial tie-rod (62) extend over said first elongated element (64) and said second elongated element (65) forming reinforcing ribs (72) in reinforcing planes parallel to said axial direction (A-A) and said radial direction (R-R),
and/or wherein
the tangential distance between said first axial tie-rod (61) and said second axial tie-rod (62) is between three times and one and a half times the thrust portion width (36) of the spring thrust portion (9);
and/or wherein
said brake caliper (16) comprises at least one strip spring and brake pad assembly (1), wherein the tangential tie-rod (63) is provided with opposite shaped seats for housing the end part of the coupling portion (8) of the strip spring (2);
or wherein
said brake caliper (16) comprises at least one strip spring and brake pad assembly (1), wherein the tangential tie-rod (63) is provided with opposite shaped seats for housing the end part of the coupling portion (8) of the strip spring (2), wherein the tangential tie-rod (63) comprises a shaped recess for housing as an undercut the ends provided with radial curls of the coupling portion (8), facilitating the snap-insertion of the spring onto the tangential tie-rod and ensuring a secure coupling which prevents the spring from accidentally slipping out from the caliper body (7).

15. A brake pad (5) for a brake caliper (7), wherein said brake pad (5) defines an axial direction (A-A), a radial direction (R-R) perpendicular to the axial direction (A-A), and a circumferential direction (C-C), perpendicular to both said axial direction (A-A) and said radial direction (R-R),
comprising a plate (10) and a friction material (11) supported by the plate (10), wherein the friction material (11) is adapted to contact a braking surface (4) of a brake disc (3), wherein said brake disc (3) has a rotation axis (X-X) about which it rotates, wherein the rotation axis (X-X) is parallel to the axial direction (A-A),
wherein the plate (10) comprises a first tangentially outer edge (14) and a second tangentially outer edge (15), which are diametrically opposite or specular with respect to a centerline plane (A-R), wherein said centerline plane (A-R) is parallel to said axial direction (A-A) and said radial direction (R-R),
wherein the plate (10) comprises a radially outer edge (16) and a radially inner edge (17),
wherein said radially outer edge (16) faces at least partially along said radial direction (R-R) radially outwards (R-O) away from the rotation axis (X-X), wherein said radially inner edge (16) faces at least partially along said radial direction (R-R) radially inwards (R-I) towards the rotation axis (X-X),
wherein said radially outer edge (16) comprises at least two thrust portions (12, 112) adapted to be contacted by at least two strip springs (2, 102) to each receive an elastic bias away from the brake disc (3),
wherein each thrust portion (12) is delimited at least by a ramp (18), wherein the ramp (18) is inclined at least with respect to the axial direction (A-A) and said radial direction (R-R),
wherein said ramp (18) faces the same side as the friction material (11),
wherein said ramp (18) extends radially and axially away from said friction material (11) between a radially inner edge (19) to a radially outer edge (20),
wherein said radially outer edge (20) extends at least in the radial direction (R-R) and at least in the circumferential direction (C-C), equally spaced apart from said centerline plane (A-R) with respect to the specular ramp (18),
wherein said radially outer edge (20) comprises at least a first convex portion (21), wherein said first convex portion (21) forms a first concavity facing radially inwards (R-I),
wherein said first convex portion (21) comprises a first central part (22), a first side part (23), and a second side part (24), wherein the first central part (22) is interposed between the first side part (23) and the second side part (24), so that the strip spring (2) is adapted to apply said elastic bias at least partially to the first central part (22) of said first convex portion (21), biasing said brake pad (5) at least away from said brake disc (3) in the axial direction (A-A), avoiding contacting the first side part (23) and the second side part (24) of said first convex portion (21).
